(19) United States
(12) Patent Application Publication
(10) Pub. No.: US 2012/0236267 A1
(43) Pub. Date: Sep. 20, 2012

(54) Screen Device and Rear Projection Apparatus

(75) Inventor: Shigekazu Yamagishi, Osaka (JP)

(73) Assignee: PANASONIC CORPORATION, Osaka (JP)

(21) Appl. No.: 13/421,868

(22) Filed: Mar. 16, 2012

(30) Foreign Application Priority Data
Mar. 16, 2011 (JP) 2011-057492
Mar. 8, 2012 (JP) 2012-052031

(51) Int. Cl. G03B 21/62; G03B 21/58

(52) U.S. Cl. 353/85; 359/460; 359/457

(57) ABSTRACT

A screen device includes: a screen 102 transmitting and diffusing image light from a back side thereof; a storage section 101 rolling up and storing the screen 102 therein; and a shading member 111 covering over the back of the screen 102 such that a space through the image light toward the screen 102 passes is formed between the shading member 111 and the screen 102. The screen 102 is extendable by moving a second edge thereof, lying opposite to a first edge thereof attached to the storage section 101, upward or downward away from the storage section 101. The shading member 111 is attached at one edge thereof to on object alongside the screen-device storage section 101 side in a state where the shading member covers over the back of the screen 102, and another edge thereof lying opposite to the one edge is connected to the second edge.

### BACKGROUND OF THE INVENTION

1. Field of the Invention

The present invention relates to a screen device including a transmission type screen and a projection apparatus including the screen device, and particularly, relates to an apparatus which projects image light from the back of a screen.

2. Description of the Background Art

Projection apparatuses have widely been used for information sharing means using a large screen. A projection apparatus includes an image projecting device (projector) and an image display section (screen) which displays image light emitted by the image projecting device. The projector may be put on a desk and perform projection therefrom on a screen installed parallel to the wall of one face of a room, or may be installed on a ceiling and perform projection therefrom on the screen. In particular, when the frequency of use is high, the latter form is often used.

In recent years, thin and large-screen systems such as liquid crystal televisions and plasma display panel televisions have been sold at reasonable prices. Meanwhile, for a projector, in many cases an image display section is a flexible screen. Thus, there is no concern that an injury is suffered due to collision with the screen. In addition, when the screen is not used, the screen is rolled up and stored, so that a limited space can effectively be used. Therefore, projection apparatuses are optimum systems which are easier to introduce for educational demands such as schools.

However, in many cases, a projection apparatus is a front projection type which performs projection on a screen from the viewer side. The front projection type does not require a space behind the screen and its cost is low. However, in the front projection type, when the environment is bright, the black level increases by the environmental brightness so that the contrast greatly deteriorates, resulting in poor visibility. In order to achieve practical contrast for the black level, it is necessary to significantly increase the white level, and thus it is necessary to introduce a high-luminance projector, namely, an expensive and large-size projector. In reality, it is difficult to realize this, and viewers are forced to watch a low-contrast image in many cases.

Therefore, conventionally, for the front projection type, a configuration with a polarizing screen and a configuration with a screen including a louver which can select incident light have been proposed.

However, the configuration with the polarizing screen has the following problems: an image projecting device is limited to a type which projects polarized light; the gain of the screen is high and the view angle is low; and the screen is likely to wrinkle. Thus, this configuration has not widely been used in reality. Meanwhile, the configuration with the screen including the louver which can select incident light is effective for light from a limited direction. However, this configuration has the following problems: since external light is incident from various directions, an effect may not be able to be exerted; when the effect is enhanced, angle restriction also occurs on the viewer side, resulting in a less viewable image; due to interference between pixels of a projected image and the louver, moiré occurs; and the screen is expensive. Thus, this configuration has not widely been used.

### SUMMARY OF THE INVENTION

A screen device according to the present invention includes: a screen for transmitting and diffusing image light from a back side of the screen; a storage section for rolling up and storing the screen therein; and a shading member for covering over the back of the screen in such a way that a space through which the image light heading toward the screen passes is formed between the shading member and the screen. The screen has a first edge attached to the storage section and a second edge lying opposite to the first edge. The screen is extendable by moving the second edge upward or downward away from the storage section. The shading member has one edge attached to an object alongside the screen-device storage section side and another edge lying opposite to the one edge in a state where the shading member covers over the back of the screen. The another edge is connected to the second edge.

The shading member is composed of a stretchable sheet element, and stretches to cover over the back of the screen when the second edge is moved away from the storage section.

The screen device further includes a folding mechanism for folding the shading member outside the storage section when the screen is stored into the storage section.

The shading member is composed of a stretchable sheet element, and stretches to cover over the back of the screen when the second edge is moved away from the storage section, and the folding mechanism is moved by contraction force of the shading member when the screen is stored into the storage section.

The folding mechanism includes a guide member rotatably supported by an object alongside the screen-device storage section side, and rotates the guide member upward to fold the shading member into a state in which a site within the shading member where the guide member is attached juts out toward the back side.

The screen is connected at only the second edge thereof to the shading member.

A bar-shaped guide member is attached to the second edge of the screen so as to extend along the second edge, and the shading member and the second edge are connected to each other via the bar-shaped guide member.

The screen is a sheet element in which within a matrix a material having a different refractive index is dispersed.

The screen device further includes a defining section configured to define a frontward/backward tilt of the screen to a predetermined tilt.

The defining means provides a force pulling the second edge of the screen backward.

The defining means is a wire drawn from a take-up machine on the storage section side and attached at an end thereof to a rotating member which is rotatably provided on the bar-shaped guide member.

A plurality of vertical guide wires are provided on both side edges of the screen, respectively. Each vertical guide wire vertically connects an end of the bar-shaped guide member to an object alongside the screen-device storage section side. Each vertical guide wire is taken up together with the screen. Each vertical guide wire is connected to its side edge of the screen at a plurality of locations, and is pulled by the bar-shaped guide member in a bent state to pull the side edge of the screen outward in a horizontal direction.

The screen includes an optical section configured to control the optical path of light incident on an incident surface thereof or near the incident surface.

The optical means can be a Fresnel lens.

Further, a rear projection apparatus according to the present invention includes the screen device and an image projecting device emitting image light on the screen of the screen device, through the back, to display a projected image on the screen.

The image projecting device includes a short focus projection optical system in which the ratio W/L of the width W of the projected image and a projection distance L is greater than or equal to 5.

The image projecting device includes a section configured to continuously adjust the brightness of the projected image in a vertical direction.

### BRIEF DESCRIPTION OF THE DRAWINGS

FIG. 1 is a configuration diagram of a rear projection apparatus according to Embodiment 1;

FIG. 2 is a partial configuration diagram of a screen according to Embodiment 1;

FIG. 3 is a perspective view of an image projecting device of the rear projection apparatus according to Embodiment 1;

FIG. 4 is a front view of the rear projection apparatus according to Embodiment 1;

FIG. 5 is a pair of diagrams for illustrating the dimension positions of the width W of a projected image and a projection distance L by the short focus image projecting device according to Embodiment 1 ((a) is a perspective view as seen from the back side, and (b) is a top view);

FIG. 6 is a schematic configuration diagram before a shading member is folded by a folding mechanism according to Embodiment 1;

FIG. 7 is a schematic configuration diagram after the shading member is folded by the folding mechanism according to Embodiment 1;

FIG. 8 is a front view of a rear projection apparatus according to Embodiment 2;

FIG. 9 is a rear view of the rear projection apparatus according to Embodiment 2;

FIG. 10 is a perspective view showing a stored state of the rear projection apparatus according to Embodiment 2;

FIG. 11 is a configuration diagram of another example of a screen positioning structure; and

FIG. 12 is a configuration diagram of a rear projection apparatus of a floor-mounted form.

### DESCRIPTION OF THE PREFERRED EMBODIMENTS

### Embodiment 1

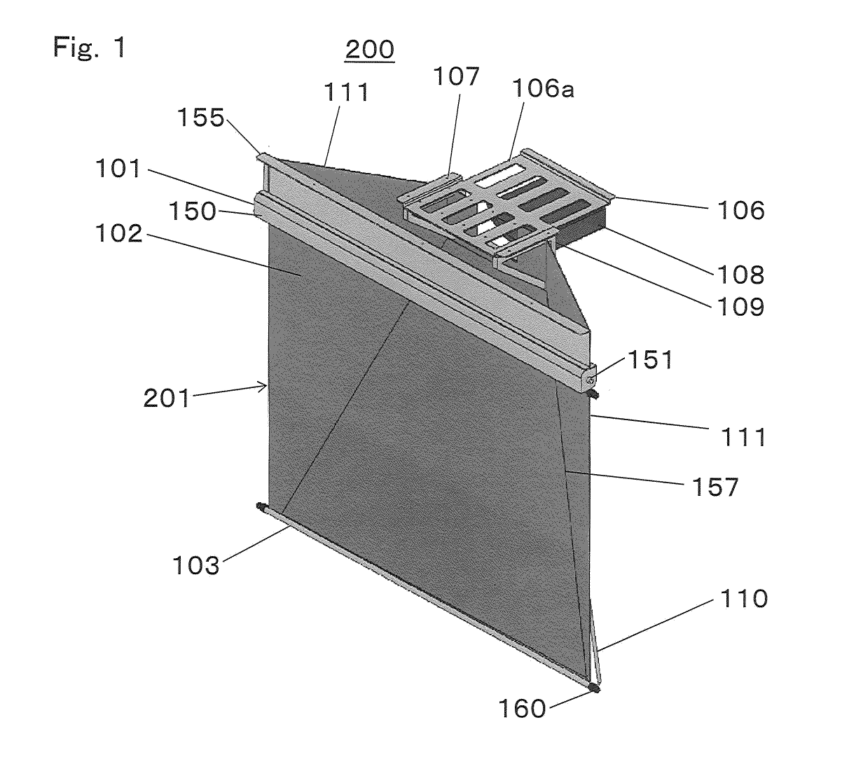

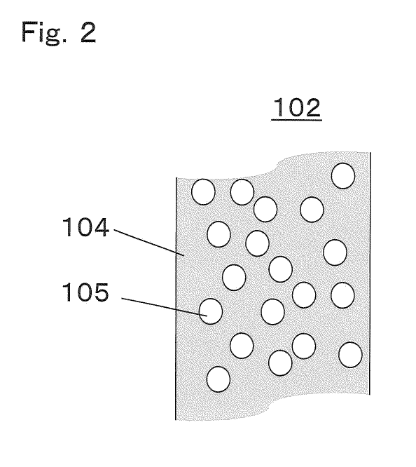

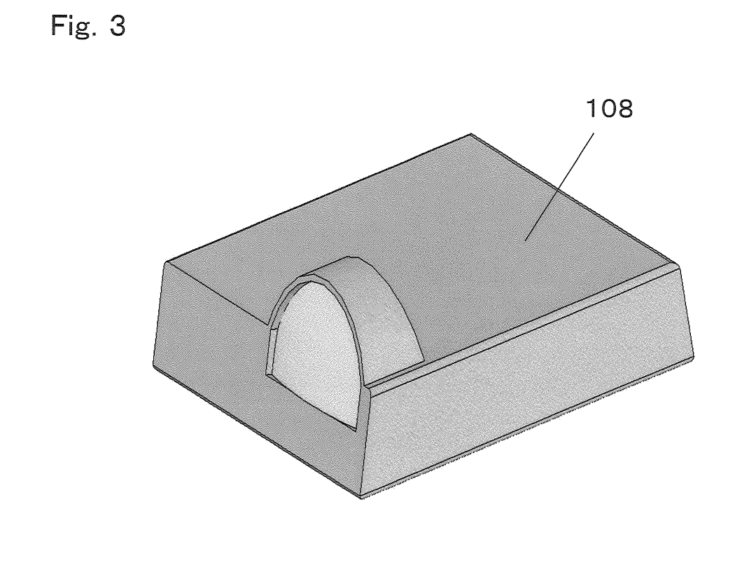

FIG. 1 is a configuration diagram of a rear projection apparatus 200 according to Embodiment 1 of the present invention; FIG. 2 is a partial configuration diagram of a screen 102; and FIG. 3 is a perspective view of an image projecting device 108. The image projecting device 108 is a short focus type image projecting device (hereinafter, referred to as short focus image projecting device).

The rear projection apparatus 200 includes a screen device 201 and the short focus image projecting device 108. The screen device 201 includes a base metal fitting 106, the screen 102, a storage section 101, and a shading member 111. The base metal fitting 106 is a fitting for attaching the screen device 201 to a ceiling. The screen 102 transmits and diffuses image light from a back side of the screen 102. The storage section 101 rolls up and stores the screen 102 therein. The shading member 111 covers over the back of the screen 102 in such a way that an image light passing space through which image light travelling from the short focus image projecting device 108 toward the screen 102 passes is formed between the shading member 111 and the screen 102. The shading member 111 has one edge (an upper edge in FIG. 1) attached to an object alongside the screen-device storage section 101 side in the vertical direction (e.g., a member of the screen device 201 or a member constituting a ceiling surface), and another edge (a lower edge in FIG. 1) lying opposite to the one edge in a state where the shading member 111 covers over the back of the screen 102.

The screen 102 can be rolled up by a drive section (not shown) and stored in the storage section 101 in FIG. 1, and is a rectangular light-transmissive sheet (a horizontally long rectangular sheet in Embodiment 1). In the screen 102, a portion along the upper long side of the four sides is referred to a “first edge”, and a portion along the lower long side of the four sides is referred to as a “second edge”. The first edge is attached to a take-up roller 151 within a later-described storage box 150 of the storage section 101. The second edge is a portion lying opposite to the first edge in a state where the screen 102 is extended (hereinafter, this state is referred to as an “extended state”). The screen 102 taken up by the take-up roller 151 is drawn downward due to the weight of a bar-shaped guide member 103 which is fixed to the second edge. When the bar-shaped guide member 103 is drawn downward, the second edge moves downward away from the storage section 101 and the screen 102 comes into the extended state.

As shown in FIG. 2, the screen 102 is composed of a screen base material 104 which transmits light and a light-transmissive material 105 which is contained in the screen base material 104 and has a refractive index different from that of the screen base material 104. The screen 102 diffuses and transmits incident light in a wide angle.

Meanwhile, the base metal fitting 106 has a plurality of holes 107 for screws for attaching the base metal fitting 106 to a ceiling, and also has an attaching hole to which the short focus image projecting device 108 can be fixed. The base metal fitting 106 is a metal fitting which can be installed on a ceiling or a floor, but may be a metal fitting which can be installed on the upper portion of a wall surface. In addition, the base metal fitting 106 is provided with vertical support members 109 which extend downward from a body 106a (a substantially rectangular plate attached to the ceiling surface so as to be substantially parallel to the ceiling surface) of the base metal fitting 106. The vertical support members 109 are provided on both sides of the body 106a of the base metal fitting 106 in a lateral direction (in a lateral direction when the screen 102 is seen from a front side thereof), respectively. Each vertical support member 109 is provided on the front side of the base metal fitting 106.

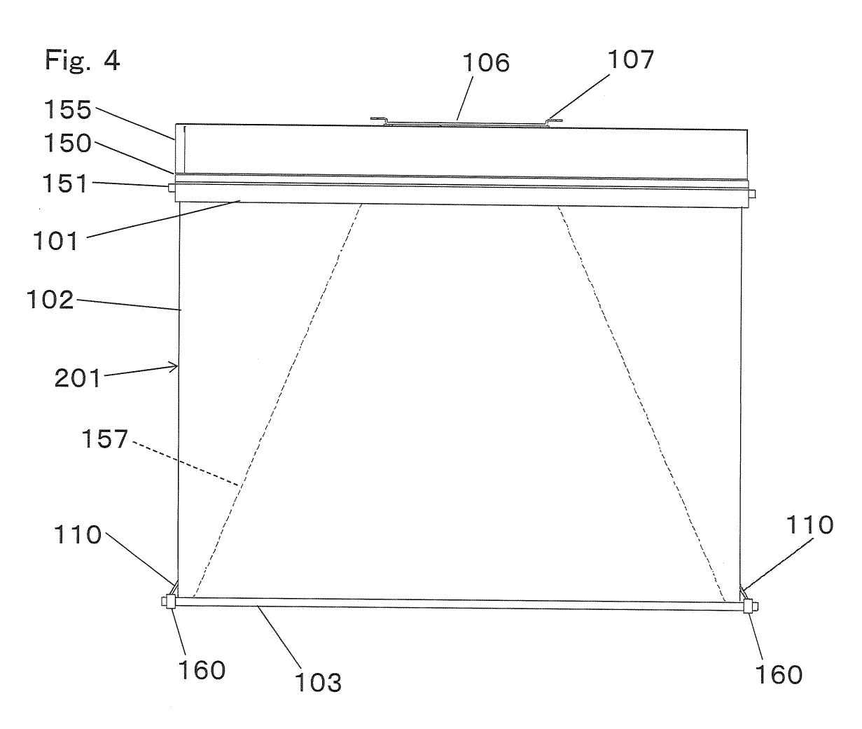

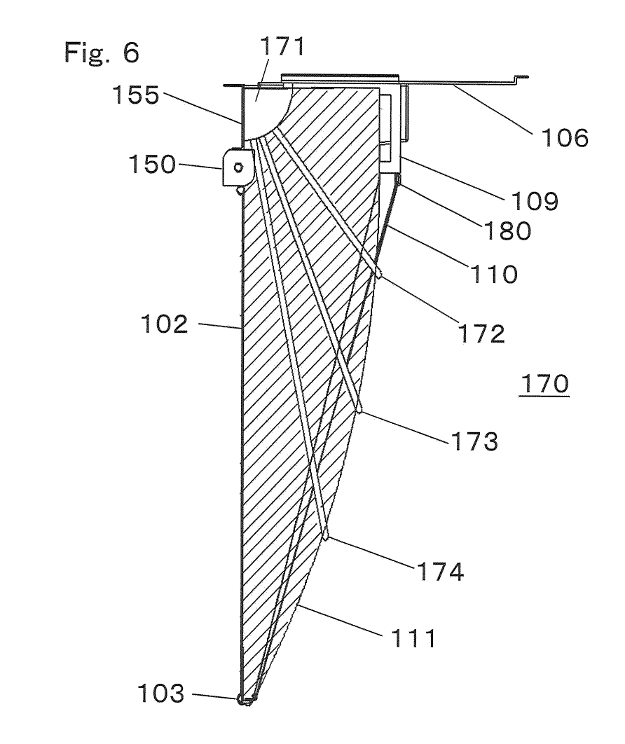

A plurality of flexible wires 110 are provided between the vertical support members 109 and the bar-shaped guide member 103 in order that the distance between the short focus image projecting device 108 and the screen 102 is kept constant. The upper ends of the wires 110 are attached to wire take-up machines 180 (see FIG. 6) which are attached to the vertical support member 109, respectively. As shown in FIG. 4, the lower ends of the wires 110 are attached to rotating rings 160 which are rotatably attached to the ends of the bar-shaped guide member 103, respectively. The end of the bar-shaped guide member 103 is inserted into the rotating ring 160. The rotating rings 160 are provided on both ends of the bar-shaped guide member 103, respectively. In Embodiment 1, the two rotating rings 160 are provided, and the wires 110 having the same lengths are provided corresponding to the rotating rings 160. The material of the wires 110 is not limited to metal and may be, for example, resin.

The storage section 101 includes the storage box 150 for storing the screen 102 therein, the take-up roller 151 for taking up the screen 102, and the drive section (not shown) which generates a rotating force by electricity to rotate the take-up roller 151. The storage box 150 is longer than the width of the screen 102. The storage box 150 has an elongated opening formed in the lower surface thereof, through which the screen 102 passes. The opening is longer than the width of the screen 102 but shorter than the bar-shaped guide member 103. The storage box 150 is attached to the lower edge of a mounting steel member 155 attached to the ceiling. The take-up roller 151 is provided within the storage box 150 such that both ends of a shaft thereof are exposed from the storage box 150, and is rotatably supported by each end surface of the storage box 150.

For example, when a user makes an instruction to take up the screen 102 by using a remote control (not shown), the drive section rotates the take-up roller 151. By so doing, the screen 102 is taken up by the take-up roller 151. While the screen 102 is taken up, the wires 110 are taken up by the wire take-up machines 180. The take-up of the screen 102 ends when the bar-shaped guide member 103 comes into contact with the edges (the edges in the longitudinal direction) of the opening of the storage box 150. When the take-up of the screen 102 ends, the screen 102 comes into a stored state of being stored in the storage section 101. In the stored state, the substantially entireties of the wires 110 are taken up by the wire take-up machines 180. In the stored state, the take-up roller 151 is retained such that the take-up roller 151 is prevented from rotating in the direction opposite to the direction to take up the screen 102.

Meanwhile, when the user makes an instruction to unroll the screen 102 by the remote control in the stored state, the take-up roller 151 is released from the state where the take-up roller 151 is retained such that the take-up roller 151 is prevented from rotating. By so doing, the take-up roller 151 rotates due to the weight of the bar-shaped guide member 103, the bar-shaped guide member 103 moves downward, and the screen 102 is drawn from the storage box 150. In addition, with the downward movement of the bar-shaped guide member 103, a tensile force is applied from the bar-shaped guide member 103 to each wire 110, and each wire 110 is unrolled from the wire take-up machine 180. When the entirety of the screen 102 is unrolled and the entirety of each wire 110 is unrolled, the movement of the bar-shaped guide member 103 ends. Thus, the screen 102 comes into the extended state.

Here, in the extended state, the wires 110 pull the second edge of the screen 102 backward, and thus the distance between the short focus image projecting device 108 and the screen 102 is defined, thereby enabling a construct-image position to be stably ensured. In other words, in the extended state, the entirety of each wire 110 is unrolled from the wire take-up machine 180, and thus the distance from the short focus image projecting device 108 to the lower edge of the screen 102 does not vary and is constant each time the screen 102 is drawn. The wires 110 are defining means for defining the distance between the short focus image projecting device 108 and the screen 102.

The rear projection apparatus 200 includes the shading member 111 which covers over a portion other than: a light-transmitting portion of the screen 102; a ceiling contact surface of the base metal fitting 106; and a portion to which light emitted by the short focus image projecting device 108 is introduced. The shading member 111 may be, for example, a stretchable material which stretches in a state where the screen 102 is drawn down and which contracts in a state where the screen 102 is stored in the storage section 101, or may be a foldable material which is not stretchable but flexible. The shading member 111 is composed of a material which does not transmit light or is unlikely to transmit light. As the shading member 111, for example, a black sheet element is used.

The shading member 111 has a rectangular shape in a front view. Specifically, in a front view, the width of the shading member 111 is substantially equal to that of the screen 102, and its height is slightly higher than that of the screen 102. The edge of the shading member 111 is attached to the base metal fitting 106, the edge of the screen 102, and the storage section 101. The shading member 111 is fixed at the upper side thereof (namely, the storage section 101 side) to the base metal fitting 106 and the storage section 101. The shading member 111 is connected at the lower side thereof to the bar-shaped guide member 103 located at the edge of the screen 102 which can be rolled up and stored. The shading member 111 is connected to the second edge via the bar-shaped guide member 103. In addition, the lateral edges of the shading member 111 are not connected to the lateral edges (the portions along the short sides) of the screen 102. The screen 102 is connected at only the second edge thereof to the shading member 111.

Specifically, the upper portion of the shading member 111 is attached at both ends thereof to the mounting steel member 155 and the storage box 150. The upper portion of the shading member 111 is spaced apart from the central portion of the mounting steel member 155. The upper portion of the shading member 111 is cut at its part facing a projection lens of the short focus image projecting device 108. In addition, the shading member 111 forms an image light passing space having a trapezoidal cross section, between the screen 102 and the shading member 111. The cross-sectional shape of the image light passing space decreases in height and increases in upper side (the short side on the far side in FIG. 1), as distance to the lower edge of the screen 102 decreases. Moreover, in the shading member 111, the interval between folds 157 increases from the lower end of each vertical support member 109 toward the lower edge of the screen 102.

The shading member 111 is slidably attached to each wire 110 at a plurality of locations. Each wire 110 is located outside the shading member 111. In other words, a plurality of insertion members for inserting the wires 110 therethrough are attached to the outside of the shading member 111. For example, the insertion members are arranged at equal intervals substantially along the folds 157 in a state where the shading member 111 is extended. Each insertion member slidably retains the inserted wire 110.

The short focus image projecting device 108 includes an ultra short focus projection lens which has a short focal length and provides a large image at a short distance. Upon receipt of an input from an external signal source (not shown), the short focus image projecting device 108 emits image light. The image light emitted from the image projecting device 108 is incident on the back of the screen 102 and is diffused and transmitted through the screen 102. On the front of the screen 102, an image is displayed by the diffused and transmitted image light.

By providing the shading member 111 as described above, the ambient external light is blocked, and an image projected by the short focus image projecting device 108 is formed on the screen 102. This results in an image having sufficient contrast even in a bright environment. As described above, the screen 102 has a characteristic to diffuse and transmit incident light. Thus, external light incident on the screen 102 is transmitted through the screen 102 and absorbed by the shading member 111, and hence does not become stray light. Furthermore, the screen 102 does not have moiré-causing elements such as black strips used in ordinary transmission-type screens, made up of plastic plates, and thus can provide a high-definition image.

Meanwhile, with this configuration, after use, when the screen 102 is rolled up to the storage section 101 by the drive section, the bar-shaped guide member 103 is moved upward, and the wires 110 connected to the bar-shaped guide member 103 and the shading member 111 composed of the flexible material such as fiber are also drawn upward, so that a limited space can effectively be used.

The wires 110 are distance defining means for keeping the distance between the screen 102 and the short focus image projecting device 108 constant. In view of installability of the screen 102, the wires 110 are desirably attached such that the lengths thereof can be adjusted.

In order to allow a light diffused surface of the screen 102 upon which an image is displayed to be tilted frontward, the short focus image projecting device 108 is installed such that a construct-image surface of the short focus image projecting device 108 is tilted frontward, and a load is applied to each wire 110, whereby the interval between the screen 102 and the short focus image projecting device 108 can be stably kept. Specifically, by changing the overall length of each wire 110 to be used, the tilt of the screen 102 in the extended state changes. In the case where the screen 102 is hung from a ceiling, it is easy for a viewer to watch an image when the front of the screen 102 faces obliquely downward. Thus, the lengths of the wires 110 may be set such that the front of the screen 102 in the extended state faces obliquely downward. The wires 110 are defining means for not only defining the distance between the short focus image projecting device 108 and the lower edge of the screen 102 to a fixed value but also defining the frontward/backward tilt of the screen 102 to a predetermined tilt.

When a mechanism to adjust the length of each wire 110 is provided, the mechanism can make adjustments for expansion and contraction of the screen due to humidity. For example, when a length-adjusting take-up machine for taking up an unused portion of each wire 110 is provided, the length of each wire 110 can be adjusted by the take-up machine.

On the incident side of the screen 102, a Fresnel surface may be formed. By so doing, in the screen 102, an incident angle of light from the short focus image projecting device 108 to a relatively distant portion increases, and thus darkening of the portion can be remedied. Alternatively, when the short focus image projecting device 108 is configured to be able to adjust the brightness of a projected image at least in the vertical direction, the same problem can be remedied. In this case, the short focus image projecting device 108 may be configured to be able to continuously adjust the brightness of a projected image in the vertical direction.

As described above, the lower end of each wire 110 is rotatably engaged with the bar-shaped guide member 103 via the rotating ring 160. Thus, for example, even when the lengths of the two wires 110 are slightly different from each other, sagging of the screen 102 can be suppressed.

The shading member 111 is connected at only the lower edge thereof to the screen 102. In this case, external light is incident through the gap lateral to the screen 102, but is absorbed by the black shading member 111 to some extent. Thus, the problem of white floating hardly arises. On the other hand, since the side portions of the screen 102 are not connected to the shading member 111, the screen 102 can be stored with a simple configuration.

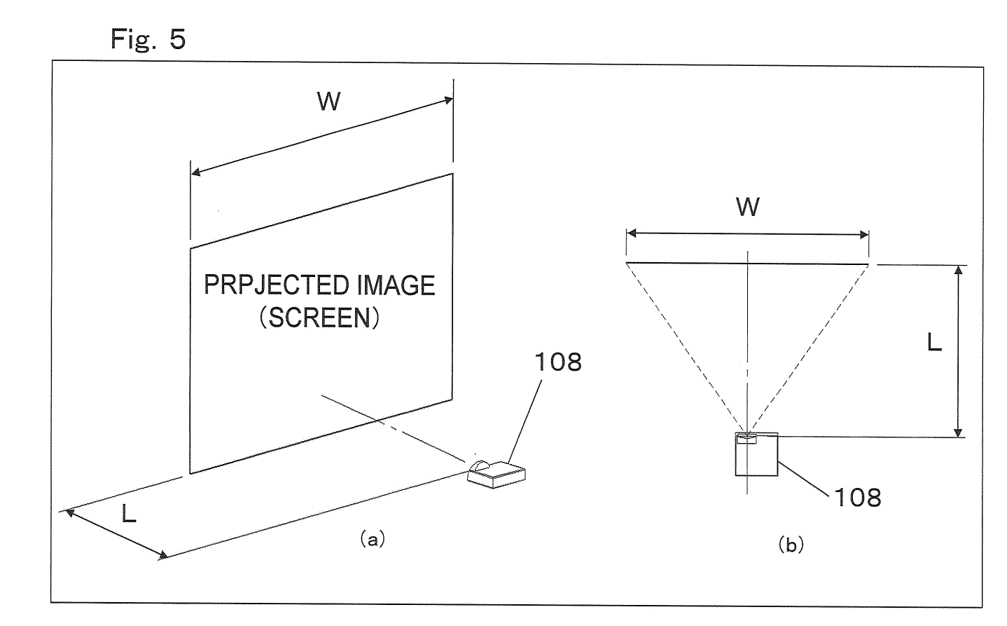

The short focus image projecting device 108 may include a short focus projection optical system which achieves that the ratio W/L of the width W of a projected image and a projection distance L (the distance (horizontal distance) from the final exit surface of the projection lens to the screen 102) is greater than or equal to 5. FIG. 5 shows a state where a projected image is displayed on the screen 102 by image light outputted from the short focus image projecting device 108 (a state of focusing on the screen 102). Thus, the entire rear projection apparatus 200 can be made thin.

In Embodiment 1, the screen 102 is moved by electric power. However, it is understood that even when a handle is provided on the bar-shaped guide member 103 and a structure to manually take up the screen 102 is provided, it is possible to configure the rear projection apparatus 200.

In Embodiment 1, in the case where the shading member 111 is a stretchable sheet element, when the second edge moves upward in storing the screen 102, the shading member 111 contracts. As a result, in the stored state of the screen 102, the shading member 111 does not become an obstacle to the user, and becomes unnoticeable.

[Modification]

The rear projection apparatus 200 includes folding mechanisms 170 which fold the shading member 111 outside the storage box 150 when the screen 102 is stored into the storage box 150. The folding mechanisms 170 are provided on both right and left sides of the screen 102 when the screen 102 is seen from the front side thereof. The folding mechanisms 170 are also applicable to Embodiment 2.

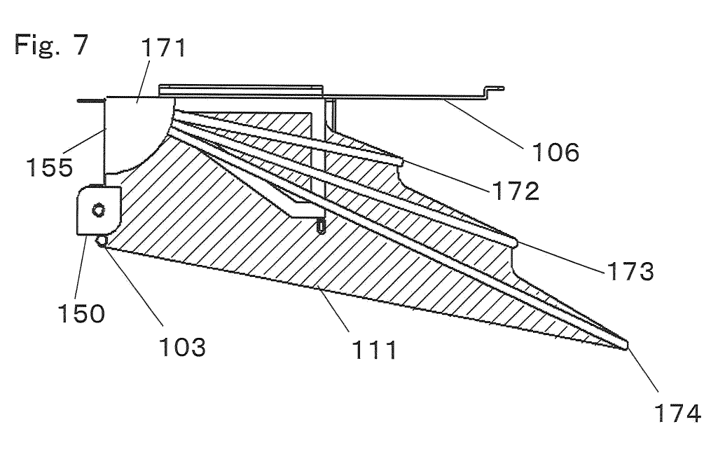

As shown in FIGS. 6 and 7, each folding mechanism 170 includes a rotation support mechanism 171 (guide hub) and guide members 172 to 174 (guide frames) which are rotatably supported by the rotation support mechanism 171. The rotation support mechanism 171 is attached to the ceiling surface or the back surface of the mounting steel member 155. Each of the guide members 172 to 174 is a lightweight and bar-shaped member. The guide members 172 to 174 are attached at lower ends thereof to the shading member 111, and serve as frames retaining the shape of the shading member 111 in the extended state. The guide members 172 to 174 retain the shape of the shading member 111 such that the lower portion of the shading member 111 in the extended state expands outwardly.

In this modification, the guide members 172 to 174 are provided outside the shading member 111. However, the guide members 172 to 174 may be provided inside the shading member 111 (namely, in the image light passing space). In addition, the number of the guide members can be one or more.

FIG. 6 shows a state prior to folding the shading member 111. When the screen 102 is rolled up from this state, the shading member 111 contracts. As a result, by the contraction force of the shading member 111, the lower ends of the guide members 172 to 174 are pulled upward, and the guide members 172 to 174 rotate upward. In other words, the folding mechanism 170 is moved by the contraction force of the shading member 111. Then, as shown in FIG. 7, when the roll-up of the screen 102 ends, the distance between the guide members 172 to 174 is decreased, and the entire shading member 111 has moved upward. The shading member 111 is folded into a state in which the sites within the shading member 111 where the guide members 172 to 174 are attached juts out toward the back side.

In this modification, the folding mechanism 170 is moved by the contraction force of the shading member 111. However, the folding mechanism 170 may be moved by using electric power or a spring such as a spiral spring.

### Embodiment 2

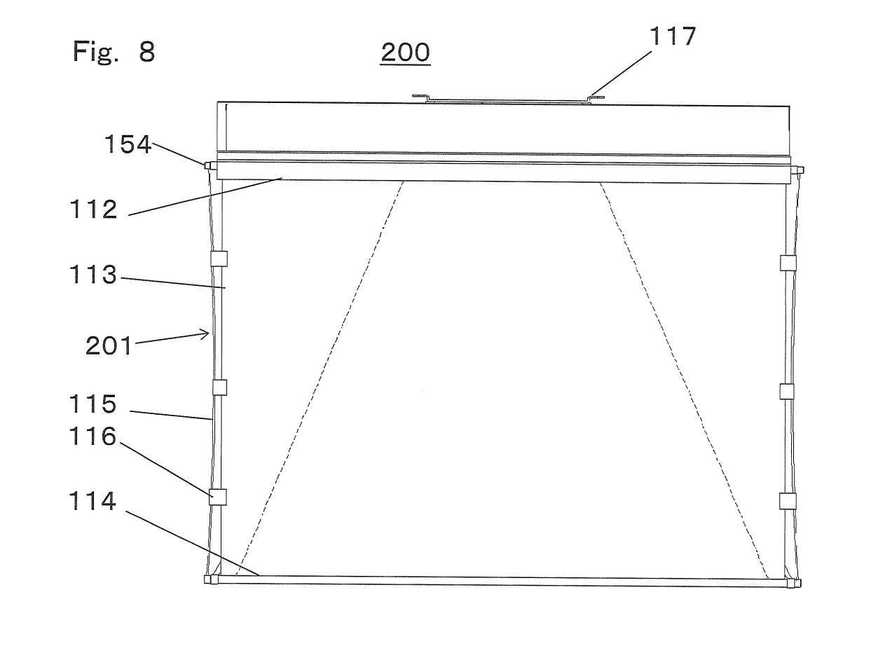

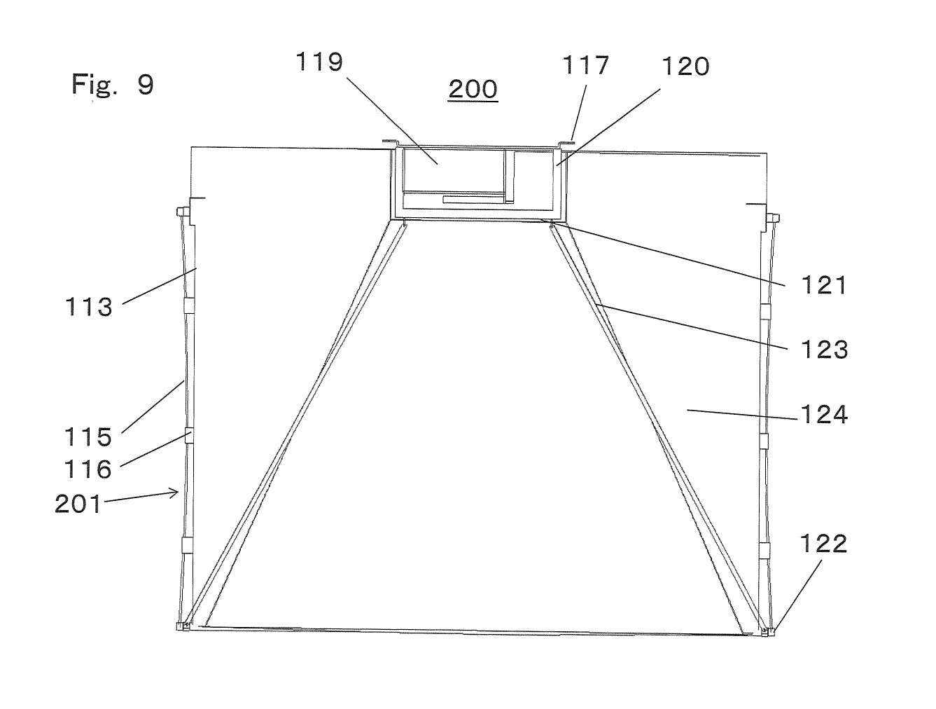

FIG. 8 is a front view of a rear projection apparatus 200 according to Embodiment 2 of the present invention, and FIG. 9 is a rear view of the rear projection apparatus 200 according to Embodiment 2 of the present invention.

A screen 113 can be rolled up by a drive section (not shown) and stored in a storage section 112, and is drawn downward due to the weight of a bar-shaped guide member 114 which is fixed to a second edge of the screen 113. On both sides of the screen 113, vertical guide wires (vertical guide shafts) 115 are provided. A horizontal direction connection means is connected between each vertical guide wire (vertical guide shaft) 115 and the screen 113 by connection members 116 at a plurality of locations, whereby a pulling force can be applied to the screen 113 in the horizontal direction. Because of this, occurrence of a warp in the edge of the screen 113 can be suppressed. Specifically, each connection member 116 is a rectangular and small fabric material which is folded back and whose both ends are fixed to the screen 113 at the same position. The guide wire 115 is inserted through the inside of the connection members 116. The guide wire 115 is connected at the upper end thereof to a take-up roller 154 and is connected at the lower end thereof to the bar-shaped guide member 114. The guide wire 115 is taken up by the take-up roller 154 together with the screen 113. When the screen 113 is in the extended state, the guide wire 115 is pulled downward by the bar-shaped guide member 114 such that the guide wire 115 is caused to attempt to extend straight, thereby pulling the folded portion of each connection member 116 outwardly.

Similarly to the screen 102, the screen 113 is composed of a screen base material 104 which transmits light and a light-transmissive material 105 which is contained in the screen base material 104 and has a refractive index different from that of the screen base material 104, and thus tends to diffuse and transmit incident light in a wide angle.

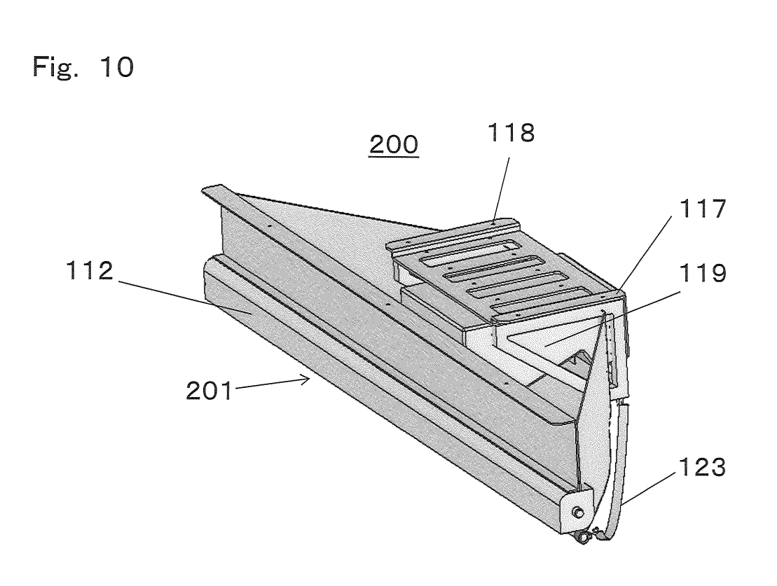

Meanwhile, a base metal fitting 117 has a plurality of holes 118 (FIG. 10) for screws for attaching the base metal fitting 117 to a ceiling, and also has a hole to which an ultra short focus image projecting device 119 is attached. The ultra short focus image projecting device 119 includes a projection optical system having a shorter focal length than that of the short focus image projecting device 108 according to Embodiment 1, and can provide a large image at a shorter distance. Since the ultra short focus image projecting device 119 is used, the entire apparatus can be made small as shown in FIG. 10.

As shown in FIG. 9, a structural metal fitting 120 is fixed to the base metal fitting 117. Between the structural metal fitting 120 and each rotating ring (rotating frame) 122, an elastic member 123 is provided as distance defining means for defining the distance between the screen 113 and the ultra short focus image projecting device 119. The elastic member 123 is composed of a band-shaped spring member, and has a linear shape when no load is applied thereto. Thus, the screen 113 can be stably positioned.

In Embodiment 2 as well, a shading member 124 is provided which covers over a portion other than a light-transmitting portion of the screen 113 and a ceiling contact surface of the base metal fitting 117. Similarly to the shading member 111 in Embodiment 1, the shading member 124 is composed of a stretchable material or a foldable and flexible material. The shading member 124 is composed of a material which does not transmit light or is unlikely to transmit light. In addition, the shading member 124 is fixed at one edge thereof to the base metal fitting 117. The shading member 124 is slidably attached at a plurality of locations to each elastic member 123 which is connected to the bar-shaped guide member 114 located at the edge of the screen 113 which can be rolled up and stored. The elastic member 123 is provided so as to extend along the outer surface of the shading member 124.

By providing such a configuration, the ambient external light is blocked, and an image projected by the ultra short focus image projecting device 119 is formed on the screen 113. This results in an image having sufficient contrast even in a bright environment. Since the screen 113 has a characteristic to diffuse and transmit incident light, external light incident on the screen 113 is transmitted through the screen 113 and absorbed by the shading member 124, and hence does not become stray light. In this case, an image is recognizable through contrast between black and white, and hence black floating is suppressed. Thus, even when light output of the ultra short focus image projecting device 119 for obtaining a white image is lower than light output of a generally used image projecting device, the same contrast is obtained. Therefore, power savings can be achieved. Reference character 121 indicates a hook for hooking the upper end of the elastic member 123 to the structural metal fitting 120.

FIG. 10 is a perspective view showing a stored state where the screen 113 is rolled up. By so storing, a limited space can effectively be used when there is no need to use the screen 113.

In this embodiment, the screen 113 is composed of a diffusing material having a characteristic to diffuse light. However, an optical means, ideally, a Fresnel sheet (a sheet-shaped Fresnel lens), may be used on the incident side of the screen 113 in order to decrease the incident angle of light. The optical means is composed of a flexible material such that the optical means can be stored. By so doing, effects such as improvement in uniformity of the brightness on the screen 113 are obtained, and the image quality can be increased.

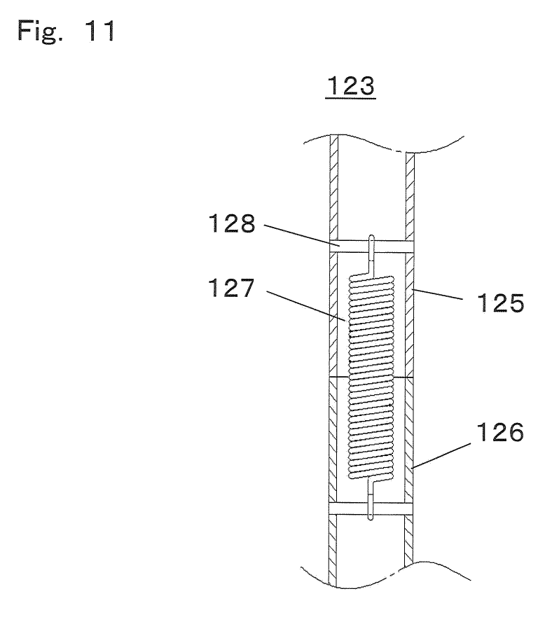

As in a configuration diagram of another example of a screen positioning structure in FIG. 11, each elastic member 123 can be configured as follows. Although not shown in FIG. 11, in the elastic member 123, a first support pipe 125 is connected at an upper end thereof to the structural metal fitting 120. Fixed pins 128 are provided in the first support pipe 125 and a second support pipe 126, and a pulling coil spring 127 is interposed between the fixed pins 128. Thus, in storing the screen 113, the elastic member 123 is bent at contact surfaces of the first support pipe 125 and the second support pipe 126. Therefore, storage of the elastic member 123 is improved. Meanwhile, when the screen 113 is extended, the first support pipe 125 and the second support pipe 126 return to the straight state by the restoring force of the pulling coil spring 127, whereby the first support pipe 125 and the second support pipe 126 are arranged along a straight line and the position of the screen 113 is kept constant. The pulling coil spring 127 is mounted in the elastic member 123 such that the pulling coil spring 127 contracts when the screen 113 is extended.

### Other Embodiments

In each embodiment described above, the shading member 111 or 124 may be stored in the bar-shaped guide member 103 or 114. In this case, the bar-shaped guide member 103 or 114 is formed in a cylindrical shape. The bar-shaped guide member 103 or 114 has an elongated opening formed in an upper portion thereof, through which the shading member 111 or 124 passes. A take-up roller for taking up the shading member 111 or 124 is rotatably supported within the bar-shaped guide member 103 or 114. The take-up roller is rotated, for example, by using an electric motor or a spring such as a spiral spring.

Further, in each embodiment described above, the bar-shaped guide member 103 or 114 may be omitted. In this case, the shading member 111 or 124 connected to the screen 102 or 113 can also be taken up by the take-up roller 151 or 154 which takes up the screen 102 or 113.

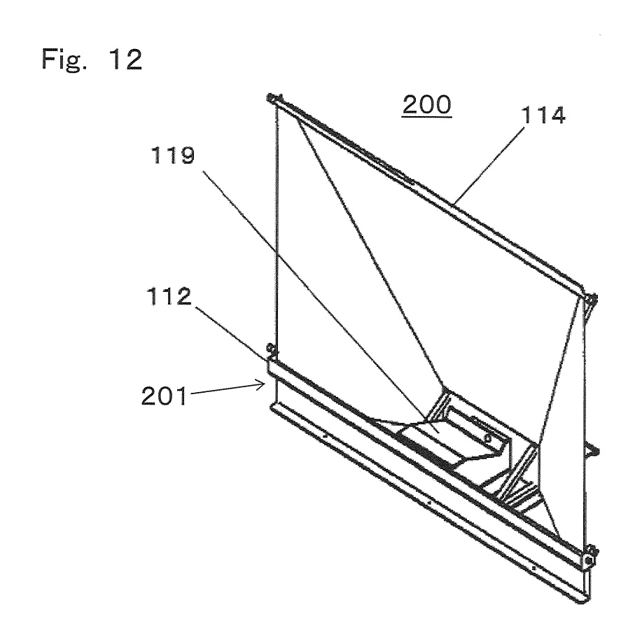

Further, in each embodiment described above, the case where the rear projection apparatus 200 is hung from a ceiling has been described. However, it is understood that the rear projection apparatus 200 can be used in a floor-mounted form as shown in a configuration diagram of a rear projection apparatus of a floor-mounted form in FIG. 12. In this case, for example, the base metal fitting 106 or 117 is attached to a floor, and the storage section 101 or 112 and the shading member 111 or 124 are attached to the base metal fitting 106 or 117.

While the invention has been described in detail, the foregoing description is in all aspects illustrative and not restrictive. It will be understood that numerous other modifications and variations can be devised without departing from the scope of the invention.

1. A screen device comprising:
a screen for transmitting and diffusing image light from a back side of the screen;
a storage section for rolling up and storing the screen therein; and
a shading member for covering over the back of the screen in such a way that a space through which image light heading toward the screen passes is formed between the shading member and the screen; wherein
the screen has a first edge attached to the storage section and a second edge lying opposite to the first edge,
the screen is extendable by moving the second edge upward or downward away from the storage section,
the shading member has one edge attached to an object alongside the screen-device storage section side and another edge lying opposite to the one edge in a state where the shading member covers over the back of the screen, and
the other edge is connected to the second edge.

2. The screen device according to claim 1, wherein the shading member is composed of a stretchable sheet element, and stretches to cover over the back of the screen when the second edge is moved away from the storage section.

3. The screen device according to claim 1, further comprising a folding mechanism for folding the shading member outside the storage section when the screen is stored into the storage section.

4. The screen device according to claim 3, wherein:
the shading member is composed of a stretchable sheet element, and stretches to cover over the back of the screen when the second edge is moved away from the storage section; and
the folding mechanism is moved by contraction force of the shading member when the screen is stored into the storage section.

5. The screen device according to claim 3, wherein the folding mechanism includes a guide member rotatably supported by an object alongside the screen-device storage section side, and rotates the guide member upward to fold the shading member into a state in which a site within the shading member where the guide member is attached juts out toward the back side.

6. The screen device according to claim 1, wherein the screen is connected at only the second edge thereof to the shading member.

7. The screen device according to claim 1, wherein:
a bar-shaped guide member is attached to the second edge of the screen so as to extend along the second edge; and
the shading member and the second edge are connected to each other via the bar-shaped guide member.

8. The screen device according to claim 1, wherein the screen is a sheet element in which within a matrix a material having a different refractive index is dispersed.

9. The screen device according to claim 1, further comprising a defining section configured to define a frontward/backward tilt of the screen to a predetermined tilt.

10. The screen device according to claim 9, wherein the defining section provides a force pulling the second edge of the screen backward.

11. The screen device according to claim 9, wherein the defining section is a wire drawn from a take-up machine on the storage section side and attached at an end thereof to a rotating member rotatably provided on the bar-shaped guide member.

12. The screen device according to claim 7, wherein:
a plurality of vertical guide wires are provided lateral to both side edges of the screen, respectively, each vertical guide wire vertically connecting an end of the bar-shaped guide member to an object alongside the screen-device storage section side, each vertical guide wire being taken up together with the screen; and
each vertical guide wire is connected to its side edge of the screen at a plurality of locations, and is pulled by the bar-shaped guide member in a bent state to pull the side edge of the screen outward in a horizontal direction.

13. The screen device according to claim 1, wherein the screen includes an optical section configured to control the optical path of light incident on an incident surface thereof or near the incident surface.

14. The screen device according to claim 13, wherein the optical means is a Fresnel lens.

15. A rear projection apparatus comprising:
a screen device according to claim 1; and
an image projecting device emitting image light on the screen of the screen device, through the back, to display a projected image on the screen.

16. The rear projection apparatus according to claim 15, wherein the image projecting device includes a short focus projection optical system in which the ratio W/L of the width W of the projected image and a projection distance L is greater than or equal to 5.

17. The rear projection apparatus according to claim 15, wherein the image projecting device includes a section configured to continuously adjust the brightness of the projected image in a vertical direction.
